(19) United States
(12) Patent Application Publication
(10) Pub. No.: US 2012/0124208 A1
(43) Pub. Date: May 17, 2012

(54) APPARATUS AND METHOD FOR TRANSMITTING CONTENTS ON A RELAY NODE BETWEEN SENDING END AND RECEIVING END

(75) Inventors: Jong-Geun PARK, Daejeon-si (KR); Soon-Seok LEE, Daejeon-si (KR)

(73) Assignee: Electronics and Telecommunications Research Institute, Daejeon-si (KR)

(21) Appl. No.: 13/297,118

(22) Filed: Nov. 15, 2011

(30) Foreign Application Priority Data
Nov. 16, 2010 (KR) 10-2010-0114014

(51) Int. Cl. G06F 15/173

(52) U.S. Cl. 709/225

(57) ABSTRACT

An apparatus and method for transmitting contents on a relay node disposed between a sending end and a receiving end is provided. If a content, which is identical to a content requested by a user terminal, is currently being transmitted or is in a waiting mode for content transmission, a relay node, for example, a router, disposed between a sending end and a receiving end duplicates the content and transmits the duplicated content to the user terminal, thereby reducing the work load of a service terminal and the network traffic load.

### CROSS-REFERENCE TO RELATED APPLICATION

This application claims the benefit under 35 U.S.C. § 119(a) of Korean Patent Application No. 10-2010-0114014, filed on Nov. 16, 2010, the disclosure of which is incorporated by reference in its entirety for all purposes.

### BACKGROUND

1. Field

The following description relates to a content transmission technique, and more particularly, to an apparatus and method for transmitting contents on a relay node between a sending end and a receiving end.

2. Description of the Related Art

In transmitting contents including a data file, such as application programs, moving pictures and images, or a moving picture streaming data, through Internet, a permission procedure for content transmission/reception and a content transmission/reception process have been achieved between service terminals, that is, a sending end and a receiving end.

However, when the permission procedure and the content transmission process are achieved, the user authentication, the confirmation of a service access right, the confirmation of a state of usability of contents, network information, such as a destination address of a server to transmit contents, and the content transmission scheme, for example, the possibility of multicasting are determined in a stage corresponding to before contents are transmitted in practice, that is, on a service establishment stage.

Accordingly, the content transmission service has been achieved only depending on the participation of user terminals and determination of a service terminal. Relay nodes only serve to relay contents between the sending end and the receiving end.

### SUMMARY

In one aspect, there is provided a technology for transmitting contents on a relay node disposed between a sending end and a receiving end, in which if a content, which is identical to a content requested by a user terminal, is currently being transmitted or is in a waiting mode for content transmission, a relay node, for example, a router, disposed between a sending end and a receiving end duplicates the content and transmits the duplicated content to the user terminal, thereby reducing the work load of a service terminal and the network traffic load.

In one general aspect, there is provided a technology for transmitting contents on a relay node disposed between a sending end and a receiving end. A content transmitting apparatus on a relay node determines whether a content being requested by a user terminal is being is transmitted or being in a waiting mode for content transmission to another user terminal. If the result of the determination is that a content being requested by a user terminal is being transmitted or being in a waiting mode for content transmission to another user terminal, a permission process for transmitting the content is complete, the content is duplicated and the duplicated content is transmitted to the user terminal having requested the content.

Accordingly, different from a conventional transmission scheme where a content transmission service is achieved mainly on a sending end and a receiving end, if a content, which is identical to a content requested by a user terminal, is currently being transmitted or is in a waiting mode for content transmission, the content is duplicated on a relay node, such as, a router disposed between a sending end and a receiving end, and the duplicated content is transmitted to a user terminal, thereby reducing the work load of a service terminal and the network traffic load.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a conceptual diagram illustrating an example of the concept of transmitting contents on a relay node disposed between a sending end and a receiving end.

FIG. 2 is a block diagram illustrating an example of the configuration of a content transmitting apparatus on a relay node disposed between a sending end and a receiving end.

FIG. 3 is a flowchart illustrating an example of a process of a content transmitting apparatus on a relay disposed between a sending end and a receiving end.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

It is expected that an increased number of contents are exchanged on a network on a network environment in the future, and in particular, some contents highly demanded by users, such as popular movies or useful programs, may take a great portion of traffic in the entire network.

Accordingly, the future network environment is expected to be developed to reduce the workload of a service terminal and the network traffic load as compared to a technology where a content transmission service is achieved mainly on a sending end and a receiving end.

To this end, the future network environment needs to be developed in a direction that a relay node, for example, a router, disposed between a sending end and a receiving end, recognizes services and application and obtains context information of a network.

In addition, a relay node, for example, a router, disposed between a sending end and a receiving end, recognizes content information and also processes a predetermined service request on its own within an allowed right without having to deliver a service request message to a server.

For example, if a user terminal requests a content, which is identical to a content that is currently being transmitted or is in a waiting mode for content transmission, a relay node, such as a router, disposed between a sending end and a receiving end, processes a permission procedure that is required to transmit the content, duplicates the content and transmits the duplicated content to the user terminal having requested the content without accessing a service terminal having the content.

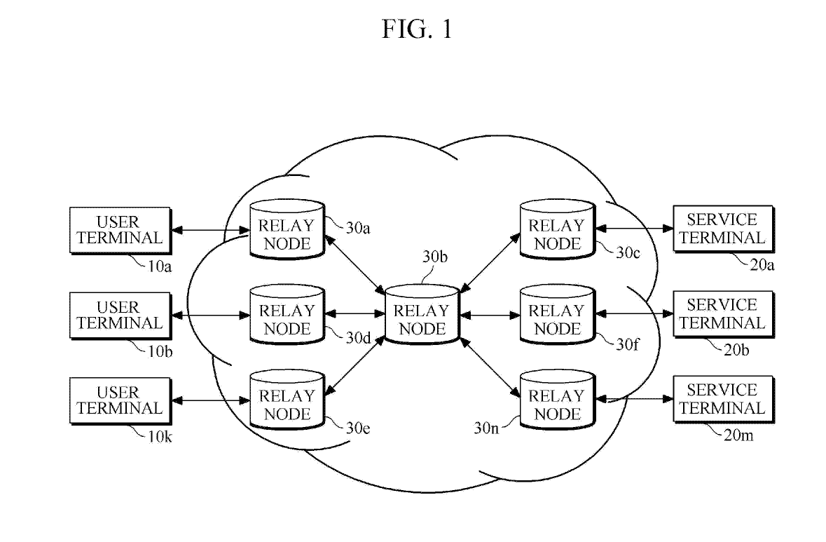

FIG. 1 is a conceptual diagram showing an example of the concept of transmitting contents ona relay node disposed between a sending end and a receiving end. As shown in FIG. 1, a network is formed using a plurality of user terminals 10a, 10b, . . . and 10k, corresponding to sending ends and receiving ends, service terminals 20a, 20b, . . . and 20m having contents, and a plurality of relay nodes 30a, 30b, . . . 30n disposed between the user terminals and the service terminals.

In the beginning, it is assumed that the user terminal 10a requests a predetermined content, a permission procedure required for content transmission between the user terminal 10a and the service terminal 20a is performed, and thus contents are transmitted to the user terminal 10a through the relay node 30a, the relay node 30b and the relay node 30c.

In this state, if another user terminal 10b requests a content which is identical to the content being transmitted to the user terminal 10a, a content request is transmitted to the relay node 30b via the relay node 30d.

At this time, the content which is identical to the content, which is requested by the user terminal 10b, is currently provided to the user terminal 10a. Accordingly, the relay node 30b performs a permission procedure required to transmit the content with respect to the service terminal 20a, duplicates the content being provided to the user terminal 10a and transmits the duplicated content to the user terminal 10b via the relay node 30d without having to transmit a content request by the user terminal 10b to a service terminal 20a.

As described above, it is not that a service terminal having contents mainly determines the multicasting for content transmission but that a relay node, for example, a router, disposed between a sending end and a receiving end participates in consideration of a content transmission state to transmit contents in a dynamic or ad-hoc manner independent of the service terminal

Accordingly, a content transmission may be achieved on a relay node, such as a router, disposed between a sending end and a receiving end, in consideration of the content transmission condition, so that the workload of a service terminal and the network traffic load are reduced as compared with a technology where a content transmission service is achieved mainly on a sending end and a receiving end.

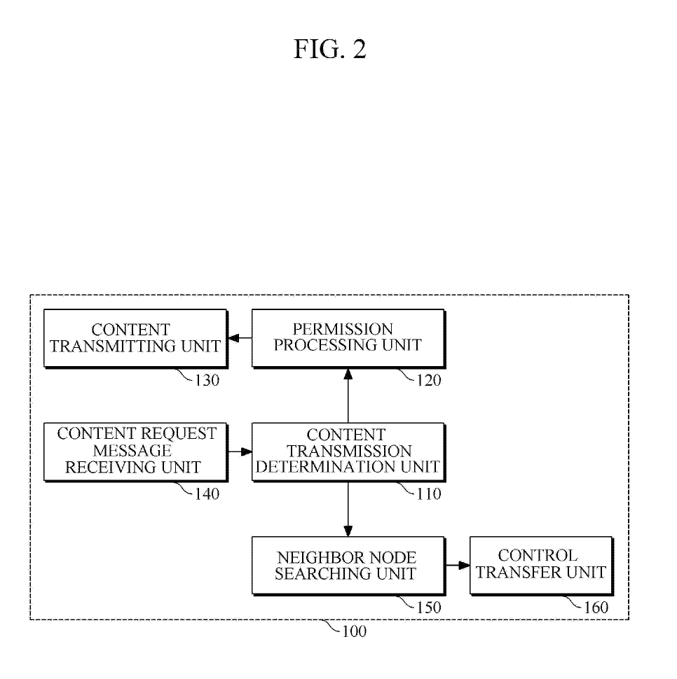

FIG. 2 is a block diagram showing an example of the configuration of a content transmitting apparatus on a relay disposed between a sending end and a receiving end. As shown in FIG. 2, an example of a content transmitting apparatus 100 on a relay node disposed between a sending end and a receiving end includes a content transmission determination unit 110, a permission processing unit 120 and a content transmitting unit 130.

The content transmission determination unit 110 determines whether a content that is requested by a user terminal is currently being transmitted or is in a waiting mode for content transmission to another user terminal. At this time, the content transmission determination unit 110 may be configured to analyze a content request message, which is received from the user terminal, to identify the content requested by the user terminal and determine whether a content, that is identical to the identified content, is currently being transmitted or is in a waiting mode for content transmission to another user terminal.

For example, the content transmission determination unit 110 determines whether a content requested by a user terminal is currently being transmitted or is in a waiting mode for content transmission to another user terminal by comparing content identification information, which is identified from a content request message, with content identification information, which is detected from meta data of a content that is currently being transmitted or is in a waiting mode for content transmission to another user terminal.

In this case, the content transmission determination unit 110 may identify the content requested by the user terminal by performing a Stateful Packet Inspection (SPI) on a header of the content request message.

Alternatively, the content transmission determination unit 110 may identify the content requested by the user terminal by performing a Deep Packet Inspection (DPI) on a payload of the content request message.

The permission processing unit 120 processes a permission procedure that is required to transmit a corresponding content, if a determination result by the content transmission determination unit 110 is that a content requested by a user terminal is currently being transmitted or is in a waiting mode for content transmission to the other user terminal.

In this case, the permission processing unit 120 transmits service permission request information, which is used to perform the permission procedure, to a service terminal that provides contents, receives result information from the service terminal in response to the service permission request information, and performs the permission procedure.

For example, the permission processing unit 120 may be configured to process authentication for a user terminal, which has requested a content, as the permission procedure. The permission processing unit 120 requests authentication for the user terminal, who has requested the content, from the service terminal that provides the content, and receives a result of the authentication for the user from the service terminal, thereby performing a permission procedure that is required to transmit the content.

For example, the permission processing unit 120 may be configured to check a service access right allowed to a user who has requested a content as the permission procedure. The permission processing unit 120 requests confirmation of the service access right of the user terminal, which has requested the content, from a service terminal that provides the contents, and receives a result of the confirmation of the service access right of the user terminal, thereby performing a permission procedure that is required to transmit the content.

For example, the permission processing unit 120 may be configured to check billing condition related to contents as the permission procedure. The permission processing unit 120 requests confirmation of a content related billing condition for a user terminal, which has requested a content, from a service terminal that provides the content, receives a result of the confirmation of a content related billing condition for the user terminal, thereby performing a permission procedure that is required to transmit the content.

The content transmitting unit 130 duplicates the requested content and transmits the duplicated content to the user terminal, which has requested the content, if the permission procedure is complete by the permission processing unit.

Accordingly, different from a conventional transmission scheme where a content transmission service is achieved mainly on a sending end and a receiving end, if a content, which is identical to a content requested by a user terminal, is currently being transmitted or is in a waiting mode for content transmission, the content is duplicated at a relay node, such as, a router disposed between a sending end and a receiving end, and the duplicated content is transmitted to a user terminal, thereby reducing the work load of a service terminal and the network traffic load.

According to another example of the content transmitting apparatus 100 may further include a content request message receiving unit 140. The content request message receiving unit 140 receives a content request message from a user terminal If a user wants to receive a content and manipulates a user terminal to request the content, a content request message is requested.

The content transmitting apparatus 100 receives the content request message through the content request message receiving unit 140. Upon reception of the content request message through the content request message receiving unit 140, the content transmitting apparatus 100 determines whether a content identical to the requested content is currently being transmitted or is in a waiting mode for content transmission to another user terminal.

If a content identical to the requested content is currently being transmitted or is in a waiting mode for content transmission to another user terminal, the content transmitting apparatus 100 duplicates the corresponding content and transmits the duplicated content to the user terminal which has requested the content. Accordingly, the workload of a service terminal and the network traffic load are reduced as compared to a technology where a content transmission service is achieved mainly on a sending end and a receiving end.

Meanwhile, the content transmitting apparatus 100 may further include a neighbor node searching unit 150.

The neighbor node searching unit 150 is configured to search to determine whether the content requested by the user terminal is currently being transmitted or is in a waiting mode for content transmission from a neighbor relay node to another user terminal, if a determination result by the content transmission determination unit 110 is that the requested content is not currently being transmitted or is not in a waiting mode for content transmission to another user terminal.

That is, in this example, if a content requested by a user terminal is not currently being transmitted or is not in a waiting mode for content transmission to another user terminal on a predetermined node, which is disposed between a sending end and a receiving end and on which the content transmitting apparatus 100 is installed, the content transmitting apparatus 100 searches for a relay node, which currently transmits or waits to transmit a content, which is identical to the content requested by the user terminal, to another user terminal among neighbor nodes.

In addition, the content transmitting apparatus 100 may further include a control transfer unit 160. The control transfer unit 160 is configured to transfer a control right on content transmission to a neighbor node if a determination result by the neighbor node searching unit 150 is that the requested content is currently being transmitted or is in a waiting mode for content transmission from the neighbor relay node to another terminal.

That is, in this example, if a content requested by a user terminal is not currently being transmitted or is not in a waiting mode for content transmission from a predetermined node, which is disposed between a sending end and a receiving end and on which the content transmitting apparatus 100 is installed, to another user terminal the content transmitting apparatus 100 transfers a control right on content transmission to a neighbor node, which currently transmits or waits for transmit a content, which is identical to the content requested by the user terminal As a result, contents are transmitted to user terminals through relay nodes between sending ends and receiving ends tents without a service terminal's participation.

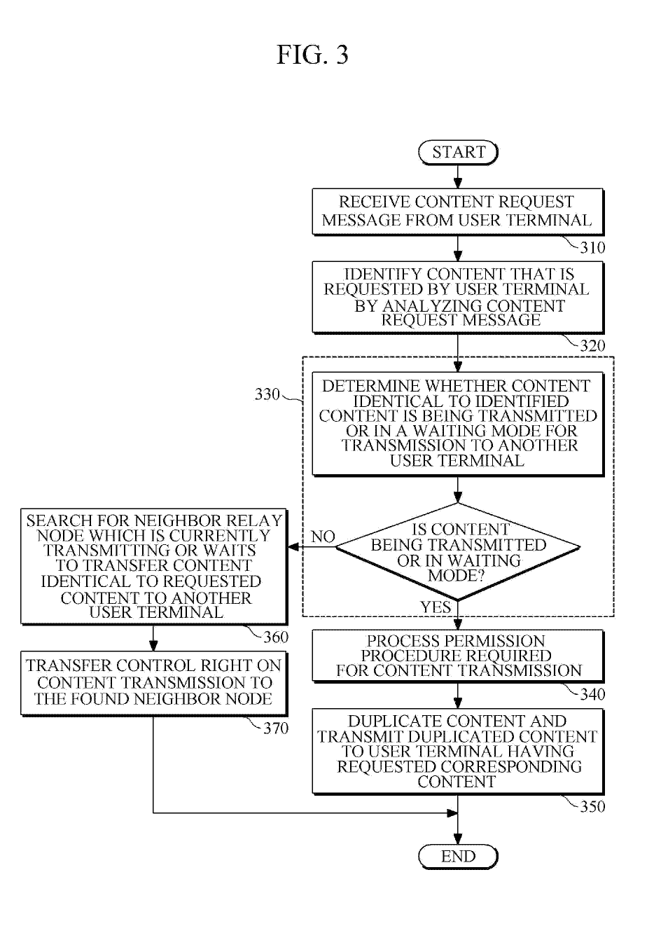

Hereinafter, a content transmission operation of the content transmitting apparatus 100 having the above configuration will be described with reference to FIG. 3. FIG. 3 is a flowchart illustrating an example of a process of a content transmitting apparatus on a relay disposed between a sending end and a receiving end.

A content request message is transmitted from a user terminal and the content transmitting apparatus 100 on a relay node disposed between a sending end and a receiving end receives the content request message from the user terminal (310).

The content transmitting apparatus 100 analyzes the received content request message, which is received in operation 310, to identify a content that is requested by the user terminal (320).

For example, in operation 320, the content transmitting apparatus 100 may identify the content requested by the user terminal by performing a Stateful Packet Inspection (SPI) on a header of the content request message.

For example, in operation 320, the content transmitting apparatus 100 may identify the content requested by the user terminal by performing a Deep Packet Inspection (DPI) on a payload of the content request message.

Thereafter, the content transmitting apparatus 100 determines whether a content, which is identical to the content identified in operation 320, is currently being transmitted or is in a waiting mode for content transmission to another user terminal (330).

For example, in operation 330, the content transmitting apparatus 100 compares content identification information, which is identified from the content request message, with content identification information, which is detected from meta data of a content that is currently being transmitted or is in a waiting mode for content transmission to another user terminal, thereby determining whether the content requested by the user terminal is currently being transmitted or is in a waiting mode for content transmission to another user terminal.

Thereafter, the content transmitting apparatus 100 processes a permission procedure that is required for content transmission (340), if a determination result by operation 330 is that the content requested by the user terminal is currently being transmitted or is in a waiting mode for content transmission.

In operation 340, the content transmitting apparatus 100 transmits service permission request information, which is used to perform the permission procedure, to a service terminal, which provides the content, receives result information from the service terminal in response to the service permission request information, and performs the permission procedure.

For example, in operation 340, the content transmitting apparatus 100 may process authentication for a user, who requests the content, in the permission procedure.

For example, in operation 340, the content transmitting apparatus 100 may check a service access right allowed to a user who requests the content in the permission procedure.

For example, in operation 340, the content transmitting apparatus 100 may check billing condition related to contents of user, who requests the content, in the permission procedure.

Thereafter, the content transmitting apparatus 100 duplicates the corresponding content and transmits the duplicated content to the user terminal (350) if the permission procedure is complete in operation 340.

If a result of determination of operation 330 is that the content requested by the user terminal is not currently being transmitted or is not in a waiting mode for content transmission to another user terminal, the content transmitting apparatus 100 searches for a neighbor relay node, which is currently being transmitting or being in a waiting mode to transmit a content t, which is identical to the requested content, to another user terminal (360). The content transmitting apparatus 100 transfers a control right on content transmission to the neighbor node which has been found in operation 360 (370).

As described above, if a content, which is identical to a content requested by at user terminal, is currently being transmitted or is in a waiting mode for content transmission to another user terminal, the content transmitting apparatus 100 on a relay node disposed between a sending end and a receiving end duplicates the content and transmits the duplicated content to the user terminal, so that the workload of a service terminal and the network traffic load are reduced as compared with a transmission scheme where a content transmission service is achieved mainly on a sending end and a receiving end.

The present invention is applicable in the photographing control technology field and the application technology field.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A content transmitting apparatus on a relay node disposed between a sending end and a receiving end, the apparatus comprising:
a content transmission determination unit configured to determine whether a content that is requested by a user terminal is currently being transmitted or is in a waiting mode for content transmission to another user terminal;
a permission processing unit configured to, if a determination result by the content transmission determination unit is that a content requested by a user terminal is currently being transmitted or is in a waiting mode for content transmission to another user terminal, process a permission procedure that is required to transmit the content; and
a content transmitting unit configured to, if the permission procedure is complete by the permission processing unit, duplicate the requested content and transmit the duplicated content to the user terminal having requested the content.

2. The content transmitting apparatus of claim 1, wherein the content transmission determination unit analyzes a content request message, which is received from the user terminal, to identify the content requested by the user terminal, and determines whether a content, that is identical to the identified content, is currently being transmitted or is in a waiting mode for content transmission to another user terminal.

3. The content transmitting apparatus of claim 2, wherein the content transmission determination unit determines whether the content requested by the user terminal is currently being transmitted or is in a waiting mode for content transmission to another user terminal by comparing content identification information, which is identified from the content request message, with content identification information, which is detected from meta data of a content that is currently being transmitted or is in a waiting mode for content transmission to another user terminal.

4. The content transmitting apparatus of claim 2, wherein the content transmission determination unit identifies the content requested by the user terminal by performing a Stateful Packet Inspection (SPI) on a header of the content request message.

5. The content transmitting apparatus of claim 2, wherein the content transmission determination unit identifies the content requested by the user terminal by performing a Deep Packet Inspection (DPI) on a payload of the content request message.

6. The content transmitting apparatus of claim 2, further comprising a content request message receiving unit configured to receive the content request message from the user terminal.

7. The content transmitting apparatus of claim 1, wherein the permission processing unit transmits service permission request information, which is used to perform the permission procedure, to a service terminal that provides contents, receives result information from the service terminal in response to the service permission request information, and performs the permission procedure.

8. The content transmitting apparatus of claim 7, wherein the permission processing unit processes authentication for the user, which has requested the content, as the permission procedure.

9. The content transmitting apparatus of claim 7, wherein the permission processing unit checks a service access right, which is allowed to the user who has requested the content, as the permission procedure.

10. The content transmitting apparatus of claim 8, wherein the permission processing unit checks billing condition related to contents as the permission procedure.

11. The content transmitting apparatus of claim 1, further comprising
a neighbor node searching unit configured to perform search to determine whether the content requested by the user terminal is currently being transmitted or is in a waiting mode for content transmission from a neighbor relay node to another user terminal if a determination result by the content transmission determination unit is that the content requested by the user terminal is not currently being transmitted or is not in a waiting mode for content transmission to another user terminal.

12. The content transmitting apparatus of claim 11, further comprising
a control transfer unit configured to transfer a control right on content transmission to the neighbor node if a determination result by the neighbor node searching unit is that the content requested by the user terminal is currently being transmitted or is in a waiting mode for content transmission from the neighbor relay node to the other user terminal.

13. A method of transmitting contents on a relay node that is disposed between a sending end and a receiving end, the method comprising:
at a content transmission apparatus on the relay node, receiving a content request message from a user terminal;
at the content transmission apparatus, identifying a content which is requested by the user terminal by analyzing the received content request message;
at the content transmission apparatus, determining whether a content, that is identical to the identified content, is currently being transmitted or is in a waiting mode for content transmission to another user terminal;
at the content transmission apparatus, processing a permission procedure that is required to transmit the content, if a determination result by the determining of content transmission is that the content requested by the user terminal is currently being transmitted or is in a waiting mode for content transmission to the other user terminal; and
at the content transmission apparatus, duplicating the requested content and transmitting the duplicated content to the user terminal, which has requested the content, if the permission procedure is complete in the processing of the permission procedure.

14. The method of claim 13, wherein in the determining of content transmission, the content transmission apparatus compares content identification information, which is identified from the content request message, with content identification information, which is detected from meta data of a content being currently transmitted or being in a waiting mode for content transmission to the other user terminal thereby determining whether the content requested by the user terminal is currently being transmitted or is in a waiting mode for content transmission to another user terminal.

15. The method of claim 13, wherein in the processing of the permission procedure, the content transmission apparatus transmits service permission request information, which is used to perform the permission procedure that is required to transmit the content, to a service terminal that provides contents, receives result information from the service terminal in response to the service permission request information, and performs the permission procedure.

16. The method of claim 15, wherein in the processing of the permission procedure, the content transmission apparatus processes authentication for the user, which has requested the content, as the permission procedure.

17. The method of claim 15, wherein in the processing of the permission procedure, the content transmission apparatus checks a service accessing right that is allowed to the user who has requested the content as the permission procedure.

18. The method of claim 15, wherein in the processing of the permission procedure, the content transmission apparatus checks billing condition related to contents as the permission procedure.

19. The method of claim 13, further comprising
at the content transmission apparatus, searching to determine whether the content requested by the user terminal is currently being transmitted or is in a waiting mode for content transmission from a neighbor relay node to another user terminal, if a determination result by the determining of content transmission is that the content requested by the user terminal is not currently being transmitted or is not in a waiting mode for content transmission to another user terminal; and
at the content transmission apparatus, transferring a control right on content transmission to a neighbor node that is found in the searching.
